(19) United States
(12) Patent Application Publication
(10) Pub. No.: US 2023/0081262 A1
(43) Pub. Date: Mar. 16, 2023

(54) PRECIOUS METAL AUTHENTICATION SYSTEM AND METHOD

(71) Applicant: NFTOT LLC, Fort Lee, NJ (US)

(72) Inventors: In Kyung HONG, Seoul (KR); Yong Ha LEE, Gangwon-do (KR); Joon Hee HAN, Gyeonggi-do (KR); John Joonho PARK, Gyeonggi-do (KR)

(21) Appl. No.: 17/546,185

(22) Filed: Dec. 9, 2021

(30) Foreign Application Priority Data
Sep. 13, 2021 (KR) 10-2021-0121895

(51) Int. Cl. G06Q 30/00; G06V 30/18

(52) U.S. Cl. CPC G06Q 30/0185; G06V 30/18

(57) ABSTRACT

A method for authentication of precious metals according to an embodiment may include: obtaining a surface image by photographing a surface of a predetermined region of the precious metal; generating an authentication value based on the obtained surface image; and determining the authenticity of the precious metal by comparing the generated authentication value with a pre-stored authentication value.

### CROSS-REFERENCE TO RELATED APPLICATION(S)

This application claims priority to Korean Patent Application No. 10-2021-0121895 filed on Sep. 13, 2021 in the Korean Intellectual Property Office (KIPO), the entire disclosure of which is incorporated by reference herein.

### BACKGROUND

### 1. Field

The present invention generally relates to a technique of verifying the authenticity of precious metals, and more particularly, to a system and a method for authentication of precious metals.

### 2. Description of the Related Art

In general, precious metals have a large amount of circulation and are very expensive. Further, in the case of precious metal products, information on the content and origin of materials has a decisive influence on guaranteeing and determining the quality of the product. Accordingly, there is a high level of need for the precious metals to distinguish between genuine products and illegally distributed products, i.e., counterfeit products. For this reason, today, a professional appraiser issues a guarantee and certificate for each precious metal product and distributes the precious metal together therewith, thereby allowing consumers to verify the authenticity and quality of the precious metal.

However, the guarantee or certificate of authenticity is easy to forge, such that many counterfeit products and similar products that deceive information on the content, country of origin, and the like of precious metal products are in circulation, which leads to a damage to the end consumer.

Therefore, it is necessary to develop a technique that can easily and accurately verify the authenticity and quality of precious metals in the distribution process.

### SUMMARY

An object of the present invention is to provide a system and a method for authentication of precious metals, which are capable of verifying the authenticity of precious metals based on concaves and convexes on a surface of an engraved region of the precious metal.

Another object of the present invention is to provide a method for registering a precious metal authentication service, which is capable of registering an encrypted authentication value in a blockchain based on serial number information of the precious metal.

In order to achieve the above objects, according to an aspect of the present invention, there is provided a method for authentication of precious metals including: obtaining a surface image by photographing a surface of a predetermined region of the precious metal; generating an authentication value based on the obtained surface image; and determining the authenticity of the precious metal by comparing the generated authentication value with a pre-stored authentication value.

The predetermined region may be a region where characters or figures are engraved on the surface of the precious metal.

The generating the authentication value may include extracting feature information from the surface image and generating an authentication value based on the extracted feature information.

The feature information may include the number of feature points, a size and a position of each feature point, an interval between feature points, a position of each feature point group, an interval between feature point groups, the number of feature points in each feature point group, a position of each feature point in each feature point group, and an interval between the feature points in each feature point group.

The method for authentication of precious metals may further include obtaining physical property information of the precious metal, wherein the determining the authenticity of the precious metal may include determining the authenticity of the precious metal by further comparing the obtained physical property information with pre-stored physical property information.

The physical property information may include at least one of a weight, size, resistance, and resonance frequency of the precious metal.

In addition, according to another aspect of the present invention, there is provided a method for authentication of precious metals including: generating a blockchain ID based on serial number information of the precious metal; obtaining a surface image by photographing a surface of a predetermined region of the precious metal; generating an authentication value based on the obtained surface image; transmitting the generated blockchain ID to a blockchain and receiving an authentication value corresponding to the blockchain ID from the blockchain; and determining the authenticity of the precious metal by comparing the received authentication value with the generated authentication value.

The blockchain ID may be a blockchain address.

The predetermined region may be a region where characters or figures are engraved on the surface of the precious metal.

The generating the authentication value may include extracting feature information from the surface image and generating an authentication value based on the extracted feature information.

The feature information may include the number of feature points, a size and a position of each feature point, an interval between feature points, a position of each feature point group, an interval between feature point groups, the number of feature points in each feature point group, a position of each feature point in each feature point group, and an interval between the feature points in each feature point group.

The method for authentication of precious metals may further include: obtaining physical property information of the precious metal; and receiving physical property information corresponding to the blockchain ID from the blockchain, wherein the determining the authenticity of the precious metal may include determining the authenticity of the precious metal by further comparing the obtained physical property information with the received physical property information.

The physical property information may include at least one of a weight, size, resistance, and resonance frequency of the precious metal.

Further, according to another aspect of the present invention, there is provided a method for registering a precious metal authentication service including: generating a blockchain ID based on serial number information of the precious metal; obtaining a surface image by photographing a surface of a predetermined region of the precious metal; generating an authentication value based on the obtained surface image; encrypting the generated authentication value; and registering the encrypted authentication value in a blockchain together with the blockchain ID.

The method for registering a precious metal authentication service may further include obtaining physical property information of the precious metal, wherein the encrypting the generated authentication value may include encrypting the authentication value and the physical property information.

According to the present invention, by using the concaves and convexes existing on the surface of the engraved region, where surface wear is less likely to undergo in the distribution process, it is possible to determine the authenticity of the precious metal with high accuracy.

In addition, by using the physical property information of the precious metal, it is possible to determine whether substances constituting the precious metal are changed with high accuracy.

Further, by using the blockchain, it is possible to safely store information used for the authentication of the precious metal.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram illustrating a system for authentication of precious metals (‘precious metal authentication system’) according to an exemplary embodiment;

FIG. 2 is a diagram for describing feature information according to an exemplary embodiment;

FIG. 3 is a diagram illustrating a method for registering a precious metal authentication service (‘precious metal authentication service registration method’) according to an exemplary embodiment;

FIG. 4 is a diagram illustrating a method for authentication of precious metals (‘precious metal authentication method’) according to an exemplary embodiment;

FIG. 5 is a diagram illustrating a precious metal authentication system according to another exemplary embodiment;

FIG. 6 is a diagram illustrating a precious metal authentication service registration method according to another exemplary embodiment;

FIG. 7 is a diagram illustrating a precious metal authentication method according to another exemplary embodiment; and

FIG. 8 is a diagram for illustrating and describing a computing environment including a computing device suitable for use in exemplary embodiments.

### DETAILED DESCRIPTION

Hereinafter, embodiments will be described in detail with reference to the accompanying drawings. In denoting reference numerals to components of respective drawings, it should be noted that the same components will be denoted by the same reference numerals although they are illustrated in different drawings. Further, in description of preferred embodiments of the present invention, the publicly known functions and configurations related to the present invention, which are verified to be able to make the purport of the present invention unnecessarily obscure will not be described in detail.

Meanwhile, in respective steps, each of the steps may occur differently from the specified order unless a specific order is clearly described in the context. That is, each of the steps may be performed in the same order as the specified order, may be performed substantially simultaneously, or may be performed in the reverse order.

Further, wordings to be described below are defined in consideration of the functions in the present invention, and may differ depending on the intentions of a user or an operator or custom. Accordingly, such wordings should be defined on the basis of the contents of the overall specification.

It will be understood that, although the terms first, second, etc. may be used herein to describe various components, but these components should not be limited by these terms. These terms are used only to distinguish one component from other components. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

In addition, a division of the configuration units in the present disclosure is intended for ease of description and divided only by the main function set for each configuration unit. That is, two or more of the configuration units to be described below may be combined into a single configuration unit or formed by two or more of divisions by function into more than a single configuration unit. Further, each of the configuration units to be described below may additionally perform a part or all of the functions among functions set for other configuration units other than being responsible for the main function, and a part of the functions among the main functions set for each of the configuration units may be exclusively taken and certainly performed by other configuration units. Each of the configuration units to be described below may be implemented as hardware or software, or may be implemented as a combination of hardware and software.

The precious metals described herein may be necklaces, rings, earrings, lumps, bars, coins, etc. formed of gold, silver, platinum or the like.

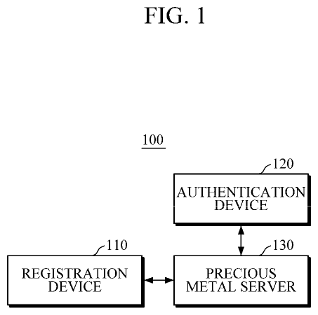

FIG. 1 is a diagram illustrating a precious metal authentication system according to an exemplary embodiment.

Referring to FIG. 1, a precious metal authentication system 100 according to an exemplary embodiment may include a registration device 110, an authentication device 120 and a precious metal server 130.

The registration device 110 may be a device equipped by a precious metal manufacturer. The registration device 110 may request to register the precious metal with a precious metal authentication service so as to verify the authenticity of the precious metal in the distribution process.

Specifically, the registration device 110 may obtain serial number information of the precious metal. For example, the registration device 110 may obtain serial number information of the precious metal by receiving the serial number information of the precious metal through a predetermined input means. As another example, the registration device 110 may obtain serial number information engraved on the precious metal by photographing the precious metal through a predetermined photographing means to obtain a precious metal image, and analyzing the obtained precious metal image.

The registration device 110 may obtain a surface image of the precious metal by photographing the surface of a predetermined region thereof. To this end, the registration device 110 may include a photographing unit such as a camera, a scanner, a microscope and the like. The predetermined region may be an engraved region where characters or figures to be displayed on the surface of the precious metal, for example, a manufacturer's name, a logo or symbol of the manufacturer, a serial number, decoration, design, purity, weight, and the like are engraved. A position of the region to be photographed, a photographing condition (e.g., a relative position of the photographing unit with respect to the precious metal), or the like may be previously set in the same manner as in the authentication device 120, but it is not limited thereto.

According to an exemplary embodiment, the registration device 110 may obtain one surface image by photographing the surface of one region, or may obtain two or more surface images by photographing the surface of two or more different regions.

The registration device 110 may obtain physical property information of the precious metal. Herein, the physical property information may include a weight, size, resistance, resonance frequency, and the like of the precious metal. For example, the registration device 110 may include a weight measurement unit, a size measurement unit, a resistance measurement unit, a resonance frequency measurement unit, and the like, and through these units, the physical property information of the precious metal may be obtained.

The registration device 110 may transmit the serial number, the surface image, and the physical property information of the precious metal to the precious metal server 130, and request to register the precious metal with the precious metal authentication service. In this case, the registration device 110 may transmit the position of the photographed region, the photographing condition (e.g., the relative position of the photographing unit with respect to the precious metal), or the like to the precious metal server 130 together therewith.

The authentication device 120 may be a device equipped by a precious metal trustee, a precious metal seller, or a precious metal purchaser. The authentication device 120 may be a device used to verify the authenticity of the precious metal in the distribution process.

Specifically, the authentication device 120 may obtain serial number information of the precious metal. For example, the authentication device 120 may obtain serial number information of the precious metal by receiving the serial number information of the precious metal through a predetermined input means. As another example, the authentication device 120 may obtain serial number information engraved on the precious metal by photographing the precious metal through a predetermined photographing means to obtain a precious metal image, and analyzing the obtained precious metal image.

The authentication device 120 may obtain a surface image by photographing the surface of a predetermined region of the precious metal. To this end, the authentication device 120 may include the photographing unit such as the camera, the scanner, the microscope and the like. The predetermined region may be the engraved region where the manufacturer's name, the logo or symbol of the manufacturer, the serial number, decoration, design, purity, weight, and the like are engraved, and may be the same region as the engraved region photographed by the registration device 110 in a precious metal authentication service registration process for the precious metal.

According to an embodiment, when the position of a predetermined region to be photographed, the photographing condition, or the like is previously set in the authentication device 120, the authentication device 120 may photograph the same surface of the region as the registration device 110 according to the set position or condition.

According to another embodiment, when the position of the region to be photographed, the photographing condition, or the like is not previously set in the authentication device 120, the authentication device 120 may transmit the serial number information to the precious metal server 130 to request the position of the region photographed by the registration device 110, the photographing condition or the like. When receiving the position of the region photographed by the registration device 110, the photographing condition, or the like from the precious metal server 130, the authentication device may photograph the surface of the same region as that of the registration device 110 based on the received information.

The authentication device 120 may obtain physical property information of the precious metal. Herein, the physical property information may include the weight, size, resistance, resonance frequency, and the like of the precious metal. For example, the authentication device 120 may include the weight measurement unit, the size measurement unit, the resistance measurement unit, the resonance frequency measurement unit, and the like, and through these units, the physical property information of the precious metal may be obtained.

The authentication device 120 may transmit the serial number, the surface image, and the physical property information of the precious metal to the precious metal server 130, and request to register the precious metal with the precious metal authentication service.

The precious metal server 130 may be a device belonging to a precious metal authentication service provider.

When receiving a precious metal authentication service registration request from the registration device 110, the precious metal server 130 may register the precious metal with the precious metal authentication service, and transmit results thereof to the registration device 110. In addition, when receiving an authentication request of the precious metal from the authentication device 120, the precious metal server 130 may determine the authenticity of the precious metal, and transmit results thereof to the authentication device 120.

Specifically, when receiving a precious metal authentication service registration request from the registration device 110, the precious metal server 130 may generate an authentication value based on the surface image received together with the precious metal authentication service registration request. For example, the precious metal server 130 may detect one or two or more feature points by analyzing the surface image of the precious metal, and extract feature information from the detected feature points. Herein, the feature point may be a portion on the surface image corresponding to the concaves and convexes of the precious metal, and the feature information may include the number of the feature points, a size and position of each feature point, and an interval between the feature points. In addition, one or two or more feature points may form feature point groups. In this case, the feature information may include a position of each feature point group, an interval between the feature point groups, the number of feature points in each feature point group, a position of each feature point in each feature point group, and an interval between the feature points. Herein, the position may indicate a relative position with respect to a predetermined reference feature point or reference feature point group. When feature information is extracted, the precious metal server 130 may generate an authentication value based on the extracted feature information.

When the authentication value is generated, the precious metal server 130 may store the serial number, the authentication value, and the physical property information of the precious metal in a database by matching, thereby registering the precious metal with the precious metal authentication service. When receiving the position of the photographed region, the photographing condition (e.g., the relative position of the photographing unit with respect to the precious metal), or the like from the registration device 110, the precious metal server 130 may also store the received information together by matching therewith.

When receiving the authenticity authentication request of the precious metal from the authentication device 120, the precious metal server 130 may generate an authentication value based on the surface image received together with the authenticity authentication request. In addition, the precious metal server 130 may search the database for an authentication value and/or physical property information matching with the serial number received together with the authenticity authentication request, and determine the authenticity of the precious metal by comparing the searched authentication value and/or physical property information with the physical property information received together with the generated authentication value and/or authenticity authentication request.

A plurality of concaves and convexes may be generated on the surface of precious metal in the manufacturing process, and these concaves and convexes may be deformed due to surface wear generated in the distribution process. However, the engraved region where the characters or figures are engraved is less likely to undergo surface wear in the general distribution process. Therefore, the engraved region has no surface wear or a very small degree of wear even if the surface wear occurs, and the surface of the engraved region of the precious metal in circulation is highly likely to be similar to the appearance at the time of initially manufacturing. Therefore, in the precious metal authentication service according to the exemplary embodiment, surface features may be defined as a combination of the plurality of concaves and convexes existing in the engraved region where the characters or figures are engraved, and it is possible to verify the authenticity of the precious metal in circulation with high accuracy by using these surface features.

In addition, the physical property information such as a weight, size, resistance, and resonance frequency of the precious metal may be related to the content of the substances constituting the same. In the precious metal authentication service according to the exemplary embodiment, it is possible to determine whether the substances constituting the precious metal have been changed in the distribution process with high accuracy by using this physical property information of the precious metal.

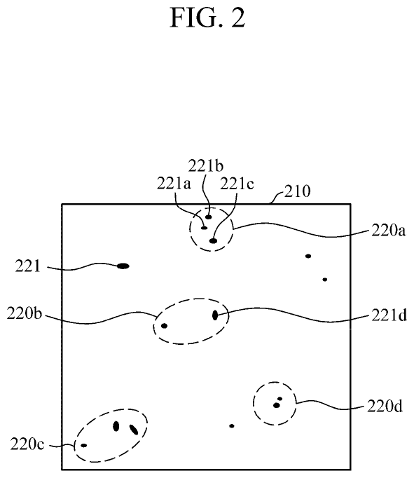

FIG. 2 is a diagram for describing feature information according to an exemplary embodiment.

Referring to FIG. 2, the surface of the engraved region of the precious metal may include the plurality of concaves and convexes generated in the manufacturing process of the precious metal, and the surface features of the precious metal may be defined by these concaves and convexes.

Feature points 221, 221a, 221b, 221c and 221d corresponding to the surface features of the precious metal are detected in the surface image 210 obtained by photographing the surface of the engraved region of the precious metal, and feature information from the detected feature points 221, 221a, 221b, 221c and 221d may be extracted.

For example, the feature information may include at least one of the number of feature points 221, 221a, 221b, 221c and 221d, a size of each feature point 221, 221a, 221b, 221c or 221d, and a relative position of each feature point 221a, 221b, 221c or 221d with respect to a reference feature point 221, an interval between the feature points 221, 221a, 221b, 221c and 221d, a relative position of each feature point group 220b, 220c or 220d with respect to a reference feature point group 220a, an interval between the feature point groups 220a, 220b, 220c and 220d, the number of feature points in each feature point group 220a, 220b, 220c or 220d, a relative position of each feature point (e.g., 221b or 221c in the case of the feature point group 220a) with respect to a reference feature point (e.g., 221a in the case of feature point group 220a) in each feature point group 220a, 220b, 220c or 220d, and an interval between the feature points (e.g., 221a, 221b and 221c in the case of the feature point group 220a). In this case, the position of each feature point group and the interval between the feature point groups may be defined based on a center of gravity of a figure formed by the feature points of each feature point group. That is, the interval between the first feature point group and the second feature point group may be determined as an interval between the center of gravity of the first feature point group and the center of gravity of the second feature point group. However, this is only an example, and it is not limited thereto.

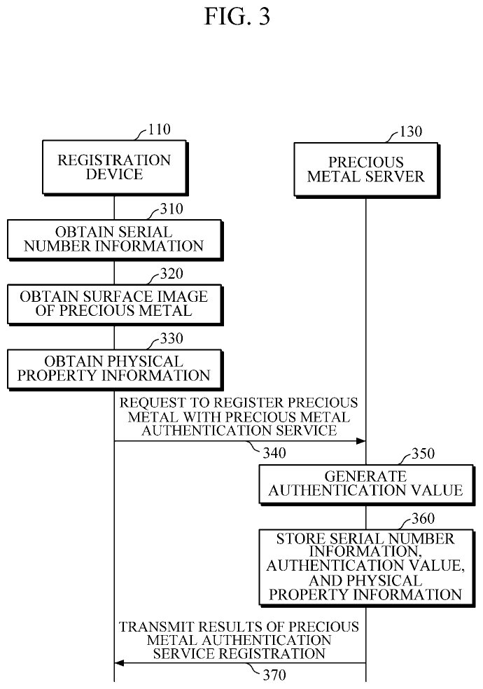

FIG. 3 is a diagram illustrating a precious metal authentication service registration method according to an exemplary embodiment.

Referring to FIG. 3, the registration device 110 may obtain serial number information of the precious metal (310), obtain a surface image by photographing the surface of a predetermined region of the precious metal thereof (320), and obtain physical property information of the precious metal (330).

The registration device 110 may transmit the obtained serial number information, the surface image, and the physical property information to the precious metal server 130 to request to register the precious metal with a precious metal authentication service (340). In this case, the registration device 110 may transmit the position of the photographed region, the photographing condition (e.g., the relative position of the photographing unit with respect to the precious metal), or the like to the precious metal server 130 together therewith.

When receiving a precious metal authentication service registration request from the registration device 110, the precious metal server 130 may generate an authentication value based on the surface image received together with the precious metal authentication service registration request (350). For example, the precious metal server 130 may detect one or two or more feature points by analyzing the surface image of the precious metal, and extract feature information from the detected feature points. In addition, when the feature information is extracted, the precious metal server 130 may generate an authentication value based on the feature information.

When the authentication value is generated, the precious metal server 130 may store the serial number, the authentication value, and the physical property information of the precious metal in the database by matching, thereby registering the precious metal with the precious metal authentication service (360). When receiving the position of the photographed region, the photographing condition (e.g., the relative position of the photographing unit with respect to the precious metal), or the like from the registration device 110, the precious metal server 130 may also store the received information together by matching therewith.

The precious metal server 130 may transmit results of the precious metal authentication service registration to the registration device 110 (370).

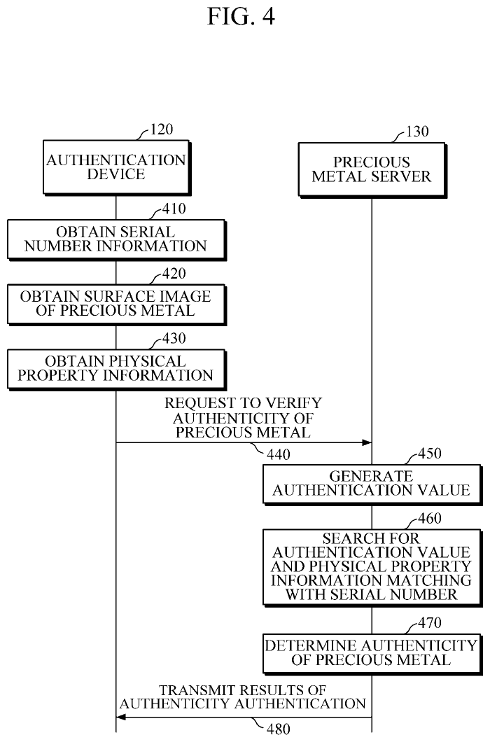

FIG. 4 is a diagram illustrating a precious metal authentication method according to an exemplary embodiment.

Referring to FIG. 4, the authentication device 120 may obtain serial number information of the precious metal (410), obtain a surface image by photographing the surface of a predetermined region of the precious metal (420), and obtain physical property information of the precious metal (430).

According to an embodiment, when the position of the region to be photographed, the photographing condition, or the like is previously set in the authentication device 120, the authentication device 120 may photograph the same surface of the region as the registration device 110 according to the set position or condition.

According to another embodiment, when the position of the region to be photographed, the photographing condition, or the like is not previously set in the authentication device 120, the authentication device 120 may transmit the serial number information to the precious metal server 130 to request the position of the region photographed by the registration device 110, the photographing condition or the like. When receiving the position of the region photographed by the registration device 110, the photographing condition, or the like from the precious metal server 130, the authentication device may photograph the surface of the same region as that of the registration device 110 based on the received information.

The authentication device 120 may transmit the serial number, the surface image, and the physical property information of the precious metal to the precious metal server 130, and request to verify the authenticity of the precious metal (440).

When receiving the authenticity authentication request of the precious metal from the authentication device 120, the precious metal server 130 may generate an authentication value based on the surface image received together with the authenticity authentication request (450).

The precious metal server 130 may search the database for an authentication value and/or physical property information matching with the serial number received together with the authenticity authentication request (460), and determine the authenticity of the precious metal by comparing the searched authentication value and/or physical property information with the physical property information received together with the generated authentication value and/or authenticity authentication request (470).

The precious metal server 130 may transmit results of the authenticity authentication to the authentication device 120 (480).

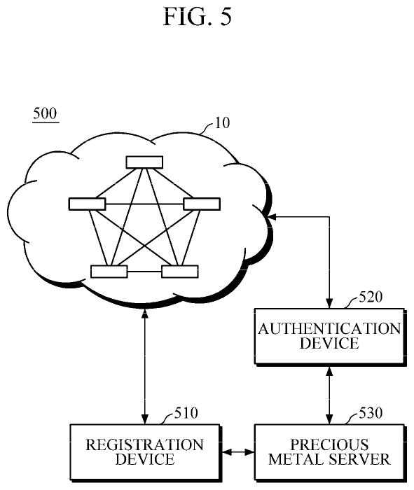

FIG. 5 is a diagram illustrating a precious metal authentication system according to another exemplary embodiment.

Referring to FIG. 5, the precious metal authentication system 500 according to this exemplary embodiment may include a registration device 510, an authentication device 520, a precious metal server 530 and a blockchain 10.

The registration device 510 may be a device equipped by the precious metal manufacturer. The registration device 510 may request to register the precious metal with the precious metal authentication service so as to verify the authenticity of the precious metal in the distribution process.

Specifically, the registration device 510 may obtain serial number information of the precious metal, and generate a blockchain ID based on the obtained serial number. For example, the registration device 510 may obtain serial number information of the precious metal by receiving the serial number information of the precious metal through a predetermined input means. As another example, the registration device 510 may obtain serial number information engraved on the precious metal by photographing the precious metal through a predetermined photographing means to obtain a precious metal image, and analyzing the obtained precious metal image. The blockchain ID may be a blockchain address.

The registration device 510 may obtain a surface image by photographing the surface of a predetermined region of the precious metal. To this end, the registration device 510 may include a photographing unit such as a camera, a scanner, a microscope and the like. The predetermined region may be the engraved region where a manufacturer's name, a logo or symbol of the manufacturer, a serial number, decoration, design, purity, weight, and the like are engraved. A position of the region to be photographed, a photographing condition (e.g., a relative position of the photographing unit with respect to the precious metal), or the like may be previously set in the same manner as in the authentication device 520, but it is not limited thereto.

According to an exemplary embodiment, the registration device 510 may obtain one surface image by photographing the surface of one region, or may obtain two or more surface images by photographing the surface of two or more different regions.

The registration device 510 may obtain physical property information of the precious metal. Herein, the physical property information may include a weight, size, resistance, resonance frequency, and the like of the precious metal. For example, the registration device 510 may include a weight measurement unit, a size measurement unit, a resistance measurement unit, a resonance frequency measurement unit, and the like, and through these units, the physical property information of the precious metal may be obtained.

The registration device 510 may transmit the blockchain ID, the surface image, and the physical property information to the precious metal server 530, and request to register the precious metal with the precious metal authentication service. In this case, the registration device 510 may transmit the position of the photographed region, the photographing condition (e.g., the relative position of the photographing unit with respect to the precious metal), or the like to the precious metal server 530 together therewith.

The registration device 510 may receive an authentication value together with results of the precious metal authentication service registration from the precious metal server 530 in response to the precious metal authentication service registration request. In this case, the authentication value may be a value generated based on the surface image transmitted to the precious metal server 530.

The registration device 510 may encrypt the authentication value, the physical property information, the position of the photographed region, the photographing condition, or the like with a private key, and transmit the encrypted information to the blockchain 10 together with the blockchain ID to register them in the blockchain 10.

Meanwhile, the blockchain 10 may issue a token according to a pre-registered smart contract. In this case, the token may be a non-fungible token (NFT) in which it is impossible to replace one token with another token.

According to one embodiment, the blockchain 10 may be a public blockchain where anyone can participate in the network, for example, Bitcoin, Ethereum, EOS, EOST, Tron, Tezos, Neo, Quantum, Stellar, Luniverse, Klaytn or the like. However, it is not limited thereto, and the blockchain 10 may be a private blockchain used independently by one institution or a consortium blockchain in which several institutions form a consortium and only authorized institutions can participate in the network.

The blockchain 10 may refer to a distributed data storage environment which stores data in blocks, then connects them in a chain form, and replicates and stores them in multiple blockchain nodes at the same time. The blockchain 10 may include multiple blockchain nodes, and the blockchain node may include a combination of various devices such as servers, personal terminals, IoT devices and the like.

The authentication device 520 may be a device equipped by a precious metal trustee, a precious metal seller, or a precious metal purchaser. The authentication device 520 may authenticate the authenticity of the precious metal in the distribution process.

Specifically, the authentication device 520 may obtain serial number information of the precious metal and generate a blockchain ID (e.g., a blockchain address) based on the obtained serial number. For example, the authentication device 520 may obtain serial number information of the precious metal by receiving the serial number information of the precious metal through a predetermined input means. As another example, the authentication device 520 may obtain serial number information engraved on the precious metal by photographing the precious metal through a predetermined photographing means to obtain a precious metal image, and analyzing the obtained precious metal image.

The authentication device 520 may obtain a surface image by photographing the surface of a predetermined region of the precious metal. To this end, the authentication device 520 may include a photographing unit such as a camera, a scanner, a microscope and the like. The predetermined region may be the engraved region where the manufacturer's name, the logo or symbol of the manufacturer, the serial number, decoration, design, purity, weight, and the like are engraved, and may be the same region as the region photographed by the registration device 510 in the precious metal authentication service registration process for the precious metal.

According to an embodiment, when the position of the region to be photographed, the photographing condition, or the like is previously set in the authentication device 520, the authentication device 520 may photograph the same surface of the region as the registration device 510 according to the set position or condition.

According to another embodiment, when the position of the region to be photographed, the photographing condition, or the like is not previously set in the authentication device 520, the authentication device 520 may transmit the blockchain ID to the precious metal server 530 to request the position of the region photographed by the registration device 510, the photographing condition or the like. When receiving the position of the region photographed by the registration device 510, the photographing condition, or the like from the precious metal server 530, the authentication device may photograph the surface of the same region as that of the registration device 510 based on the received information.

The authentication device 520 may obtain physical property information of the precious metal. Herein, the physical property information may include the weight, size, resistance, resonance frequency, and the like of the precious metal. For example, the authentication device 520 may include the weight measurement unit, the size measurement unit, the resistance measurement unit, the resonance frequency measurement unit, and the like, and through these units, the physical property information of the precious metal may be obtained.

The authentication device 520 may transmit the obtained surface image to the precious metal server 530 to request an authentication value, and receive the authentication value from the precious metal server 530. In this case, the authentication value may be a value generated based on the surface image transmitted to the precious metal server 530.

The authentication device 520 may transmit a blockchain ID to the blockchain 10 to request an authentication value and/or physical property information corresponding to the blockchain ID, and receive an authentication value and/or physical property information from the blockchain 10.

The authentication device 520 may determine the authenticity of the precious metal by comparing the authentication value and/or physical property information received from the blockchain 10 with the authentication value received from the precious metal server 530 and/or the obtained physical property information.

The precious metal server 530 may be a device belonging to the precious metal authentication service provider.

When receiving a precious metal authentication service registration request from the registration device 510, the precious metal server 530 may generate an authentication value based on the surface image received together with the precious metal authentication service registration request, and transmit the generated authentication value to the registration device 510. For example, the precious metal server 530 may detect one or two or more feature points by analyzing the surface image of the precious metal, and extract feature information from the detected feature points. Herein, the feature point may be a portion on the surface image corresponding to the concave and convex of the precious metal, and the feature information may include the number of the feature points, a size and position of each feature point, and an interval between the feature points. In addition, one or two or more feature points may form feature point groups. In this case, the surface feature information may include a position of each feature point group, an interval between the feature point groups, the number of feature points in each feature point group, a position of each feature point in each feature point group, and an interval between the feature points. Herein, the position may indicate the relative position with respect to a predetermined reference feature point or reference feature point group. When the feature information is extracted, the precious metal server 530 may generate an authentication value based on the feature information.

When the authentication value is generated, the precious metal server 530 may store the blockchain ID, the authentication value, and the physical property information in the database by matching, thereby registering the precious metal with the precious metal authentication service. When receiving the position of the photographed region, the photographing condition (e.g., the relative position of the photographing unit with respect to the precious metal), or the like from the registration device 510, the precious metal server 530 may also store the received information together by matching therewith.

The precious metal server 530 may transmit the authentication value together with results of the precious metal authentication service registration to the registration device 510 in response to the precious metal authentication service registration request.

When receiving the authentication value request from the authentication device 520, the precious metal server 530 may generate an authentication value based on the surface image received together with the authentication value request. In addition, the precious metal server 530 may transmit the generated authentication value to the authentication device 520.

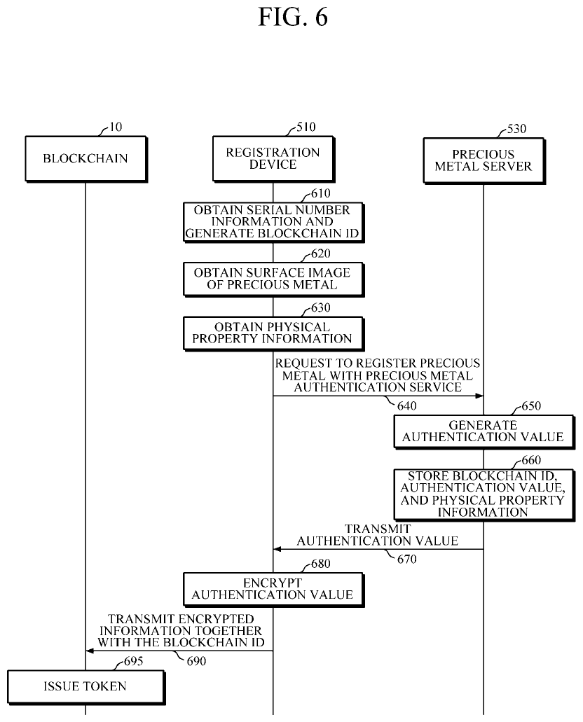

FIG. 6 is a diagram illustrating a precious metal authentication service registration method according to another exemplary embodiment.

Referring to FIG. 6, the registration device 510 may obtain serial number information of the precious metal and generate a blockchain ID based on the obtained serial number (610).

The registration device 510 may obtain a surface image of the precious metal by photographing the surface of a predetermined region (620), and enlarge it to obtain physical property information of the precious metal (630).

The registration device 510 may transmit the blockchain ID, the surface image, and the physical property information to the precious metal server 530, and request to register the precious metal with a precious metal authentication service (640). In this case, the registration device 510 may transmit the position of the photographed region, the photographing condition (e.g., the relative position of the photographing unit with respect to the precious metal), or the like to the precious metal server 530 together therewith.

When receiving a precious metal authentication service registration request from the registration device 510, the precious metal server 530 may generate an authentication value based on the surface image received together with the precious metal authentication service registration request (650). For example, the precious metal server 530 may detect one or two or more feature points by analyzing the surface image of the precious metal, and extract feature information from the detected feature points. In addition, when the feature information is extracted, the precious metal server 530 may generate an authentication value based on the feature information.

When the authentication value is generated, the precious metal server 530 may store the blockchain ID, the authentication value, and the physical property information in a database by matching, thereby registering the precious metal with the precious metal authentication service (660). When receiving the position of the photographed region, the photographing condition (e.g., the relative position of the photographing unit with respect to the precious metal), or the like from the registration device 510, the precious metal server 530 may also store the received information together by matching therewith.

The precious metal server 530 may transmit the authentication value together with results of the precious metal authentication service registration to the registration device 510 in response to the precious metal authentication service registration request (670).

When receiving the authentication value from the precious metal server 530, the registration device 510 may encrypt the authentication value, the physical property information, position of the photographed region, the photographing condition, or the like with a private key (680), and transmit the encrypted information together with the blockchain ID to the blockchain to register them in the blockchain 10 (690).

The blockchain 10 may issue a token according to a pre-registered smart contract (695). In this case, the token may be a non-fungible token (NFT) in which it is impossible to replace one token with another token.

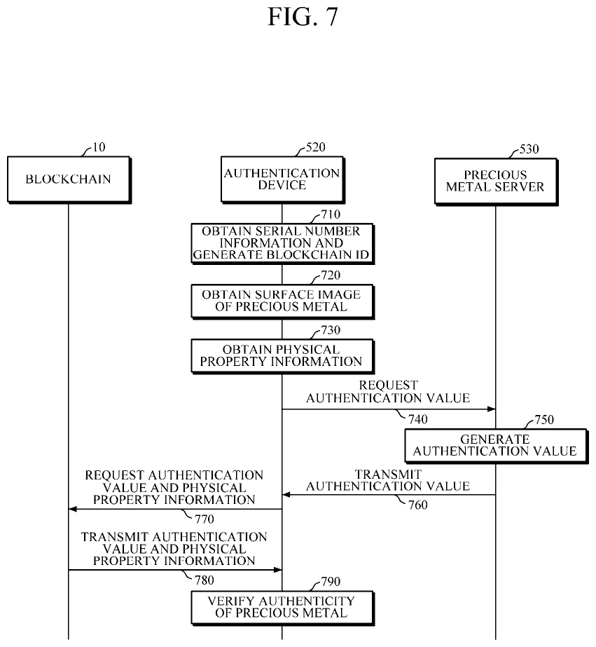

FIG. 7 is a diagram illustrating a precious metal authentication method according to another exemplary embodiment.

Referring to FIG. 7, the authentication device 520 may obtain serial number information of the precious metal and generate a blockchain ID (e.g., blockchain address) based on the obtained serial number (710).

The authentication device 520 may obtain a surface image of the precious metal by photographing the surface of a predetermined region (720).

According to an embodiment, when the position of the region to be photographed, the photographing condition, or the like is previously set in the authentication device 520, the authentication device 520 may photograph the same surface of the region as the registration device 510 according to the set position or condition.

According to another embodiment, when the position of the region to be photographed, the photographing condition, or the like is not previously set in the authentication device 520, the authentication device 520 may transmit the blockchain ID to the precious metal server 530 to request the position of the region photographed by the registration device 510, the photographing condition or the like. When receiving the position of the region photographed by the registration device 510, the photographing condition, or the like from the precious metal server 530, the authentication device may photograph the surface of the same region as that of the registration device 510 based on the received information.

The authentication device 520 may obtain physical property information of the precious metal (730). Herein, the physical property information may include the weight, size, resistance, resonance frequency, and the like of the precious metal.

The authentication device 520 may transmit the obtained surface image to the precious metal server 530 to request an authentication value (740).

When receiving the authentication value request from the authentication device 520, the precious metal server 530 may generate an authentication value based on the surface image received together with the authentication value request (750), and transmit the generated authentication value to the authentication device 520 (760)

The authentication device 520 may transmit the blockchain ID to the blockchain 10 to request an authentication value and/or physical property information corresponding to the blockchain ID (770), and receive the authentication value and/or physical property information from the blockchain 10 (780).

The authentication device 520 may determine the authenticity of the precious metal (790) by comparing the authentication value and/or physical property information received from the blockchain 10 with the authentication value received from the precious metal server 530 and/or the obtained physical property information.

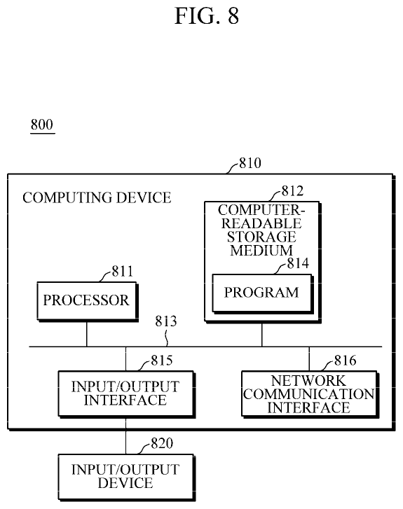

FIG. 8 is a diagram for illustrating and describing a computing environment including a computing device suitable for use in exemplary embodiments. In the illustrated embodiment, each component may have different functions and capabilities other than those described below, and the computing environment may also include additional components in addition to those described below.

A computing environment 800 illustrated in FIG. 8 may include a computing device 810. The computing device 810 may be an embodiment of registration devices 110 and 510, the authentication devices 120 and 520 and the precious metal servers 130 and 530 shown in FIG. 1 or FIG. 5.

The computing device 810 may include at least one processor 811, a computer-readable storage medium 812, and a communication bus 813. The processor 811 may cause the computing device 810 to operate according to the above-described exemplary embodiments. For example, the processor 811 may execute one or more programs 814 stored in the computer-readable storage medium 812. The one or more programs 814 may include one or more computer-executable instructions. When executed by the processor 811, the computer-executable instructions may be configured to cause the computing device 810 to perform operations according to exemplary embodiments.

The computer-readable storage medium 812 may store computer-executable instructions or program code, program data, and/or other suitable type of information. The program 814 stored in the computer-readable storage medium 812 may include a set of instructions executable by the processor 811. According to one embodiment, the computer-readable storage medium 812 may be a memory (a volatile memory, such as a random access memory, a non-volatile memory, or a suitable combination thereof), one or more magnetic disk storage devices, optical disk storage devices, flash memory, other type of storage medium accessed by the computing device 810 and capable of storing desired information, or a suitable combination thereof.

The communication bus 813 may connect various other components of the computing device 810 including the processor 811 and the computer-readable storage medium 812 with each other.

The computing device 810 may also include one or more input/output interfaces 815 and one or more network communication interfaces 816, which provide interfaces for one or more input/output devices 820. The input/output interface 815 and the network communication interface 816 may be connected to the communication bus 813. The input/output device 820 may be connected to other components of the computing device 810 through the input/output interface 815. The input/output device 820 may include, for example, a pointing device (such as a mouse or trackpad), a keyboard, a touch input device (such as a touchpad or a touchscreen), a voice or sound input device, various types of sensor devices, and/or input devices such as a photographing device, and/or output devices such as a display device, printer, speakers and/or network card. The input/output device 820 may be included in the computing device 810 as one component constituting the computing device 810 or may be connected to the computing device 810 as a separate device distinct from the computing device 810.

The embodiments of the present invention may be implemented as a computer-readable code in a computer-readable recording medium. The computer-readable recording medium may include all types of recording devices for storing data that can be read by a computer system. Examples of computer-readable recording medium may include ROM, RAM, CD-ROM, magnetic tape, floppy disk, optical disk and the like. Further, the computer-readable recording medium may be distributed over a computer system connected by a network, and written and implemented in computer-readable code that can be read by the computer in a distributed manner.

The present invention has been described with reference to the preferred embodiments above, and it will be understood by those skilled in the art that various modifications may be made within the scope without departing from essential characteristics of the present invention. Accordingly, it should be interpreted that the scope of the present invention is not limited to the above-described embodiments, and other various embodiments within the scope equivalent to those described in the claims are included within the present invention.

What is claimed is:

1. A method for authentication of precious metals, the method comprising:
obtaining a surface image by photographing a surface of a predetermined region of the precious metal;
generating an authentication value based on the obtained surface image; and
determining the authenticity of the precious metal by comparing the generated authentication value with a pre-stored authentication value.

2. The method according to claim 1, wherein the predetermined region is a region where characters or figures are engraved on the surface of the precious metal.

3. The method according to claim 1, wherein the generating the authentication value comprises extracting feature information from the surface image and generating an authentication value based on the extracted feature information.

4. The method according to claim 3, wherein the feature information comprises the number of feature points, a size and a position of each feature point, an interval between feature points, a position of each feature point group, an interval between feature point groups, the number of feature points in each feature point group, a position of each feature point in each feature point group, and an interval between the feature points in each feature point group.

5. The method according to claim 1, further comprising obtaining physical property information of the precious metal,
wherein the determining the authenticity of the precious metal comprises determining the authenticity of the precious metal by further comparing the obtained physical property information with pre-stored physical property information.

6. The method according to claim 5, wherein the physical property information comprises at least one of a weight, size, resistance, and resonance frequency of the precious metal.

7. A method for authentication of precious metals, the method comprising:
generating a blockchain ID based on serial number information of the precious metal;
obtaining a surface image by photographing a surface of a predetermined region of the precious metal;
generating an authentication value based on the obtained surface image;
transmitting the generated blockchain ID to a blockchain and receiving an authentication value corresponding to the blockchain ID from the blockchain; and
determining the authenticity of the precious metal by comparing the received authentication value with the generated authentication value.

8. The method according to claim 7, wherein the blockchain ID is a blockchain address.

9. The method according to claim 7, wherein the predetermined region is a region where characters or figures are engraved on the surface of the precious metal.

10. The method according to claim 7, wherein the generating the authentication value comprises extracting feature information from the surface image and generating an authentication value based on the extracted feature information.

11. The method according to claim 10, wherein the feature information comprises the number of feature points, a size and a position of each feature point, an interval between feature points, a position of each feature point group, an interval between feature point groups, the number of feature points in each feature point group, a position of each feature point in each feature point group, and an interval between the feature points in each feature point group.

12. The method according to claim 7, further comprising: obtaining physical property information of the precious metal; and
receiving physical property information corresponding to the blockchain ID from the blockchain,
wherein the determining the authenticity of the precious metal comprises determining the authenticity of the precious metal by further comparing the obtained physical property information with the received physical property information.

13. The method according to claim 12, wherein the physical property information comprises at least one of a weight, size, resistance, and resonance frequency of the precious metal.

14. A method for registering a precious metal authentication service, the method comprising:
generating a blockchain ID based on serial number information of the precious metal;
obtaining a surface image by photographing a surface of a predetermined region of the precious metal;
generating an authentication value based on the obtained surface image;
encrypting the generated authentication value; and
registering the encrypted authentication value in a blockchain together with the blockchain ID.

15. The method according to claim 14, further comprising: obtaining physical property information of the precious metal,
wherein the encrypting the generated authentication value comprises encrypting the authentication value and the physical property information.
